(19) United States
(12) Patent Application Publication
(10) Pub. No.: US 2019/0329439 A1
(43) Pub. Date: Oct. 31, 2019

(54) CUT-OUT TOOL

(71) Applicant: Phoenix Contact GmbH & Co. KG, Blomberg (DE)

(72) Inventors: Joachim Bury, Herford (DE); Thomas Salomon, Verl (DE)

(21) Appl. No.: 16/467,844

(22) PCT Filed: Nov. 27, 2017
(86) PCT No.: PCT/EP2017/080563

§ 371 Date: Jun. 7, 2019

(30) Foreign Application Priority Data
Dec. 8, 2016 (DE) 10 2016 123 760.4

(51) Int. Cl. B26F 1/32; B26D 5/10; B26D 7/00; B26F 1/38

(52) U.S. Cl. CPC B26F 1/32; B26F 1/3846; B26D 7/0006; B26D 5/10

(57) ABSTRACT

The invention relates to a cut-out tool configured to cut an opening into a housing wall, comprising a cut-out device arranged on an end-face section of the cut-out tool, and a thread for screwing the cut-out tool into a threaded connecting piece in or on a housing wall in order to introduce an opening into a housing wall.

### CROSS-REFERENCE TO RELATED APPLICATIONS

This application is a 371 national phase filing of International Application No. PCT/EP2017/080563, entitled “CUT-OUT TOOL”, filed 27 Nov. 2017, which claims priority to German Patent Application No. 10 2016 123 760.4, entitled “AUSTRENNWERKZEUG”, filed 8 Dec. 2016.

### BACKGROUND

The present disclosure relates to a cut-out tool for cutting an opening into a housing wall.

Some completely closed empty electronics enclosures include so-called knockout areas. These knockout areas can be knocked out of a prepared area of a housing with a tool such as a screwdriver, for example. Prerequisites for doing so are a sufficiently thin wall thickness and sufficiently brittle properties to the housing material of the empty electronics enclosure. Knocking out the knockout area thus carries the risk of inadvertent damages to the empty electronics enclosure and the sealing surfaces and of fragments being left inside the housing. All these can lead to general sealing problems and malfunctions. Furthermore, the break line can have much sharper edges, which can lead to damage to the wire insulation when line is being drawn in. In addition, there may be very limited room to maneuver when knocking out the knockout area, which could result in considerable practical problems.

Printed publication DE 20 2014 105 792 U1 discloses an improved anchor peg structure, which primarily consists of a drill screw rod, an anchor sleeve and a nut.

Printed publication DE 103 53 617 A1 teaches a method for removing solids from tubes of a tube bundle heat exchanger.

Printed publication DE 199 1 1 876 A1 teaches a method for producing a connector fitting on a hose.

### SUMMARY

The task of the present disclosure is overcoming the prior art disadvantages and providing an improved cut-out tool for cutting an opening into a housing wall.

This task is solved by the subject matter having the features as per the independent claims. Advantageous examples of the disclosure constitute the subject matter of the figures, the description and the dependent claims.

According to one aspect of the disclosure, the task is solved by a cut-out tool for cutting an opening into a housing wall which comprises a cut-out device arranged on an end-face section of the cut-out tool and a thread for screwing the cut-out tool into a threaded connecting piece in or on a housing wall in order to introduce an opening into a housing wall. This thereby achieves the technical advantage of, for example, enabling non-damaging and non-swarfing housing wall work. In doing so, simple operation as well as easy accessibility under limited spatial conditions are additionally realized, whereby it is not necessary to knock out any areas of the housing. As a result, the risk of damages to the housing wall is reduced and sealing problems can be avoided.

In order to be able to screw the cut-out tool into the housing wall in a controlled manner and at a reasonable amount of effort and to simplify the cutting out of the opening for a user of the cut-out tool, the cut-out tool has an actuating area for driving the cut-out tool by means of a tool. Any manually operable tool such as for example a screwdriver can be used here as the tool as can also a cordless screwdriver or power drill with a suitable adapter.

To make the actuating area as compatible as possible with standardized tools, the actuating area is configured to be radially or axially drivable from the inside or outside by a socket, ring or flat wrench, screwdriver, Allen wrench or cylindrical pin-like tool. This in particular enables no special tool needing to be available to drive the cut-out tool and thus allows the use of simple and commonly used tools.

According to one example, the actuating area comprises lateral openings for radially driving the cut-out tool with a rod-shaped tool. This thereby achieves the technical advantage of, for example, being able to additionally simplify the actuating of the cut-out tool by the radial inserting of a rod-shaped tool. This could be of particular importance when, for example, the thread of the cut-out tool is fully screwed into the threaded connecting piece of the housing wall and cutting out the opening is coupled with an increased effort or with a lack of the axial spatial conditions needed to use end-face driving tools. A screwdriver can thereby be introduced into the lateral opening of the actuating area in order to then enable simplified cutting with greater leverage or improved screwing and unscrewing under axially limited spatial conditions.

In order to additionally simplify the actuating of the cut-out tool by radially inserting a rod-shaped tool, the lateral openings extend completely through the actuating area of the cut-out tool. The tool can thereby be guided all the way through the cut-out tool and thus a guiding of the tool ensured.

In order to improve the reliability of the cut-out device, the end-face cut-out device is configured with multiple cutting edges. This increases the life of the cut-out device and allows longer maintenance intervals.

According to one further example, the end-face cut-out device is configured with a plurality of merging cylindrical contours. This thereby achieves the technical advantage of, for example, the cut-out tool being particularly simple to manufacture.

In order to realize particularly simple and reliable manufacture and resharpening of the cut-out device, the cut-out device comprises two cylindrical contours arranged at a 90° rotation to one another.

In order to ensure a non-swarfing and non-splintering opening cutout, the cut-out device comprises a wave-like contour.

In order to also configure the cut-out tool for particularly hard housing walls, the cut-out device comprises a sawtooth-shaped contour. In an alternative example, the cut-out device comprises a punch-like cylindrical contour for punching out the opening.

According to a further example, at least the cut-out device is configured from metal. Metal provides particularly suitable properties for the intended application of the disclosure. A metal cut-out device can thus be easily produced and yet very easily resharpened. Alternatively, however, it is likewise conceivable for the cut-out device to be produced from a ceramic material or a particularly hard plastic.

In order to keep the manufacture effort and costs low, the cut-out tool is integrally configured. Alternatively, however, it is likewise just as conceivable for the cut-out tool to be modularly configured in order to separate the actuating area from the cut-out tool. This thereby achieves the technical advantage of, for example, a uniform or standardized actuating area being combinable with different thread sizes or with different variants of cut-out devices. Different cut-out tools with differing variants of thread size and cut-out device can thus be actuated via one uniform actuating area and thus via one uniform tool.

According to one example, the actuating area and the cut-out tool are configured to be connectable via a plug connection. The plug connection may be configured in any conceivable manner. Important it is only that the necessary torque is transferable through the tool to the actuating area and from the actuating area to the cut-out device. This enables the cut-out device to be exchangeable and to be replaced when needed. Reasons for this can be needing to use other cutting geometries or other cutting sizes for other housing materials or a worn cut-out device needing to be replaced by a new cut-out device.

According to a further aspect of the disclosure, the task is solved by a mounting fixture for cutting an opening into a housing wall which comprises a cut-out tool according to one of the preceding examples and a housing wall with a threaded connecting piece, wherein the threaded connecting piece exhibits an internal thread corresponding to the thread of the cut-out tool.

According to yet a further aspect of the disclosure, the task is solved by a method for cutting an opening into a housing wall with a cut-out tool according to one of the preceding examples comprising providing a threaded connecting piece on a housing wall, screwing a cut-out tool into the threaded connecting piece, and cutting the opening into the housing wall by means of the cut-out device arranged on the end-face section of the cut-out tool. Non-damaging and non-swarfing production on the housing wall thus results. Simple operation as well as easy accessibility under limited spatial conditions are additionally realized, whereby no housing areas need to be knocked out. As a consequence, the risk of damages to the housing wall is reduced and sealing problems avoided.

Further examples of the disclosure are depicted in the drawings and will be described in greater detail below.

### BRIEF DESCRIPTION OF THE DRAWINGS

FIG. 1 shows a perspective representation of a cut-out tool,

FIG. 2A shows a representation of a cut-out tool,

FIG. 2B shows a representation of a further cut-out tool,

FIG. 2C shows a representation of yet a further cut-out tool,

FIG. 2D shows a representation of a cut-out tool with protective cap,

FIG. 2E shows a representation of a further cut-out tool with protective cap,

FIG. 2F shows a representation of yet a further cut-out tool with protective cap,

FIG. 3 shows a schematic representation of a mounting fixture,

FIG. 4 shows a further schematic representation of a mounting fixture,

FIG. 5 shows a perspective representation of a mounting fixture,

FIG. 6A shows a further perspective representation of a cut-out tool,

FIG. 6B shows yet another further perspective representation of a cut-out tool,

FIG. 6C shows yet another further perspective representation of a cut-out tool,

FIG. 7A shows a frontal representation of a cut-out tool,

FIG. 7B shows a further frontal representation of a cut-out tool, and

FIG. 7C shows yet a further frontal representation of a cut-out tool.

### DETAILED DESCRIPTION

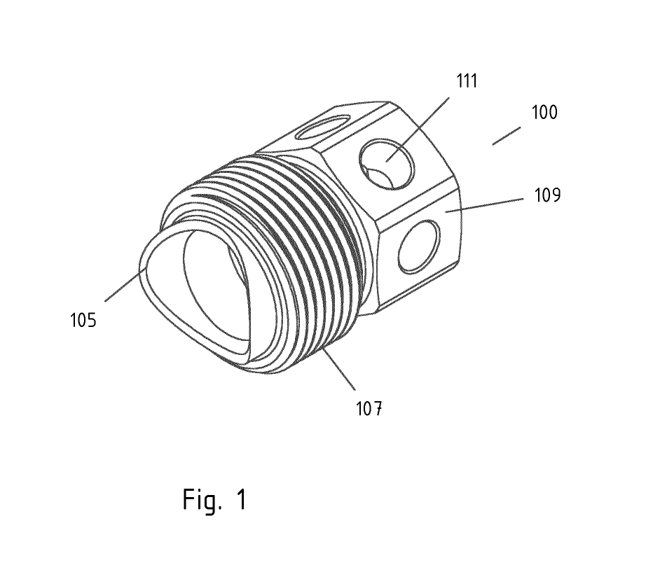

FIG. 1 shows a perspective representation of a cut-out tool 100. The cut-out tool 100 comprises a cut-out device 105 at one end of the cut-out tool 100 and a thread 107. The thread 107 is configured to correspond to a threaded connecting piece 110 (not shown) which is configured on a housing wall 103 of an empty electronics enclosure. Screwing the cut-out tool 100 into the threaded connecting piece 110 enables the cut-out device 105 as arranged to cut a defined opening 102 into the housing wall 103. In so doing, there is a greatly reduced risk of unwanted damages to the empty electronics enclosure and no fragments remain inside the housing. An actuating area 109 for driving the cut-out tool 100 by means of a tool is located on an end of the cut-out tool 100 opposite the cut-out device 105. This actuating area 109 can be actuated particularly easily with a socket, ring or flat wrench, for example. The actuating area 109 is thus accordingly configured so as to be hexagonal. A configuration to enable actuation by an Allen wrench or a screwdriver is however likewise conceivable. The actuating area 109 additionally comprises lateral openings 111. The lateral openings 111 are located on each side surface of the actuating area 109 as configured by the basic hexagonal form, wherein the driving of the cut-out tool 100 is enabled by means of a simple rod-shaped tool. A rod-shaped tool, such as a screwdriver for example, thereby only needs to be inserted into one of the lateral openings 111. This creates better leverage for a user in order to simplify the cutting into or the cutting out and opening of the housing wall 103. The cut-out device 105 at the end-face section of the cut-out tool 100 exhibits two merging cylindrical contours. These cylindrical contours are arranged at a 90° rotation to one another and comprise a wave-like contour. The cut-out tool 100 is integrally configured and consists of a metal. For cost reasons, steel or a brass alloy is particularly suitable for this purpose.

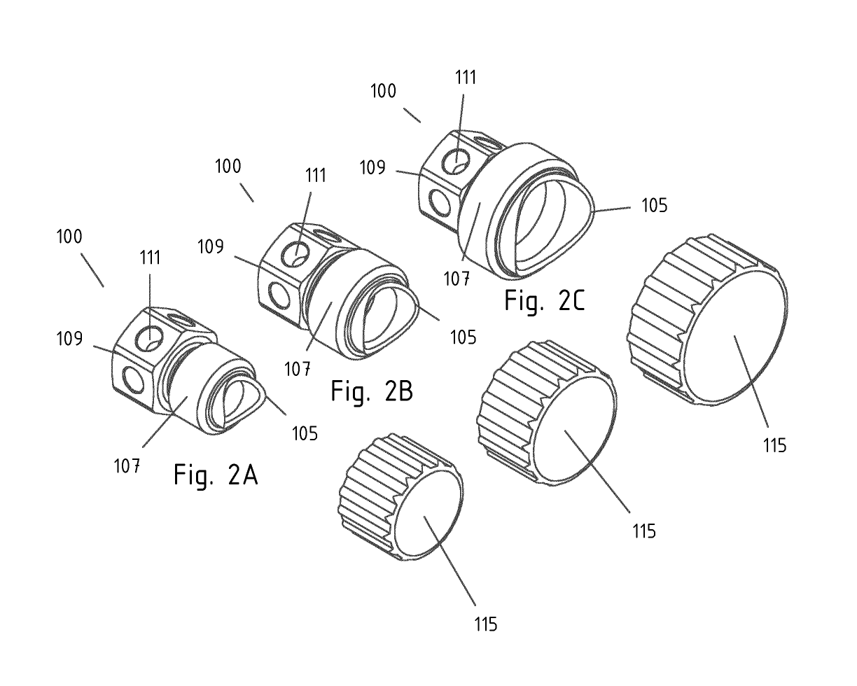

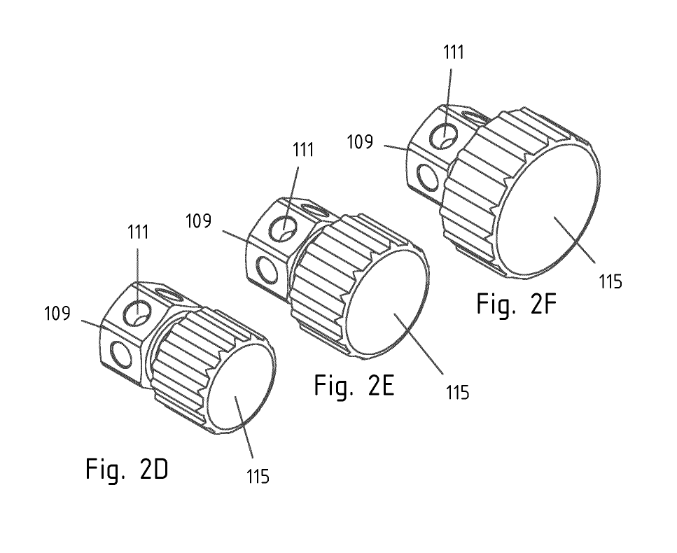

FIG. 2A shows a representation of a cut-out tool 100 with a protective cap 115. The cut-out tool 100 comprises the cut-out device 105, the thread 107 for screwing the cut-out tool 100 into a threaded connecting piece 110 of a housing wall 103, and the actuating area 109 with the laterally arranged openings 111. To protect against damages during transport and as corrosion protection for the cut-out device 105, the protective cap 115 can be arranged over the front end of the cut-out device 105. The protective cap 115 thereby comprises a respective internal thread which corresponds to the thread 107 of the cut-out tool 100. The protective cap 115 can thus be easily screwed onto the cut-out tool 100.

FIG. 2B shows a representation of a further cut-out tool 100 with protective cap 115. The thread 107 and the cut-out device 105 are of a different size compared to the cut-out tool 100 from FIG. 2a, whereby the size of the corresponding protective cap 115 is also adaptively configured.

FIG. 2C shows a representation of yet a further cut-out tool 100. The thread 107, the cut-out device 105 and the protective cap 115 are of a further different size compared to FIGS. 2a and 2b.

FIGS. 2D to 2F correspond to FIGS. 2a to 2c, whereby the respective protective cap 115 is arranged screwed onto the respective cut-out tool 100.

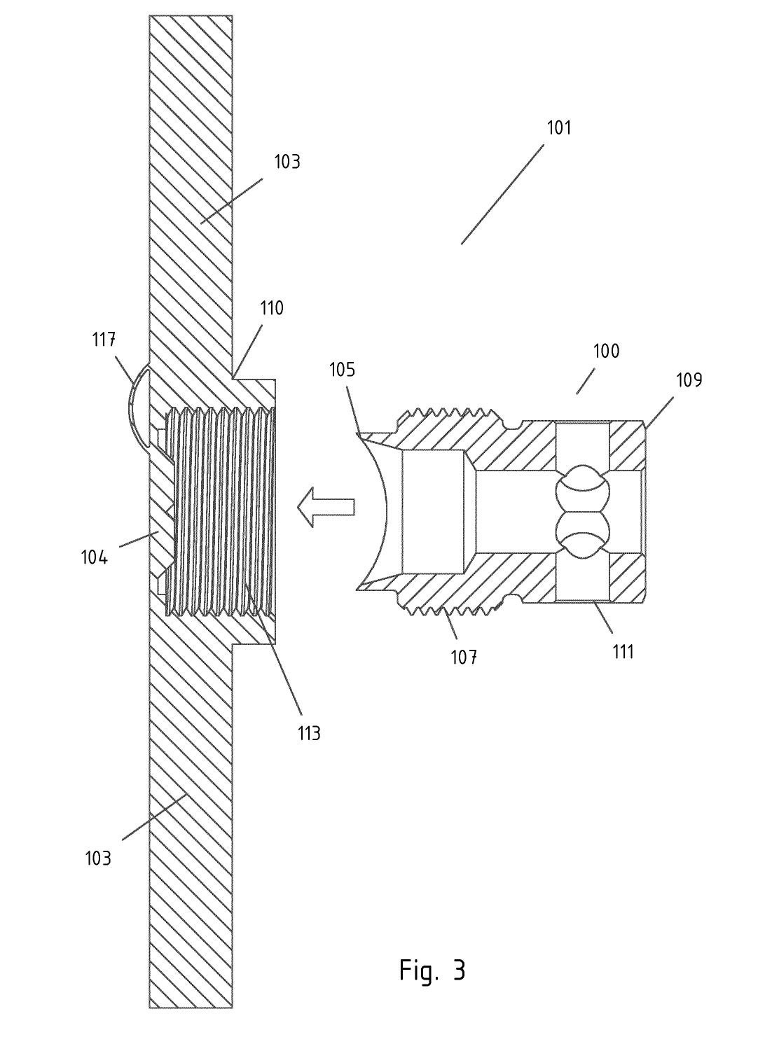

FIG. 3 shows a schematic representation of a mounting fixture 101 in a side view. The cut-out tool 100 comprises the cut-out device 105, the thread 107 and the actuating area 109 with the laterally arranged openings 111. The cut-out tool 100 is situated directly in front of a threaded connecting piece 110 of a housing wall 103, whereby the threaded connecting piece 110 comprises an internal thread 113 corresponding to the thread 107 of the cut-out tool 100. The base of the threaded connecting piece 110 is in a sealed state, wherein a cutout 104 is detachable by means of the cut-out device 105 cutting into the housing wall 103. A securing device 117 which additionally connects the cutout 104 to the housing wall 103 is situated on a side of the housing wall 103 opposite the threaded connecting piece 110.

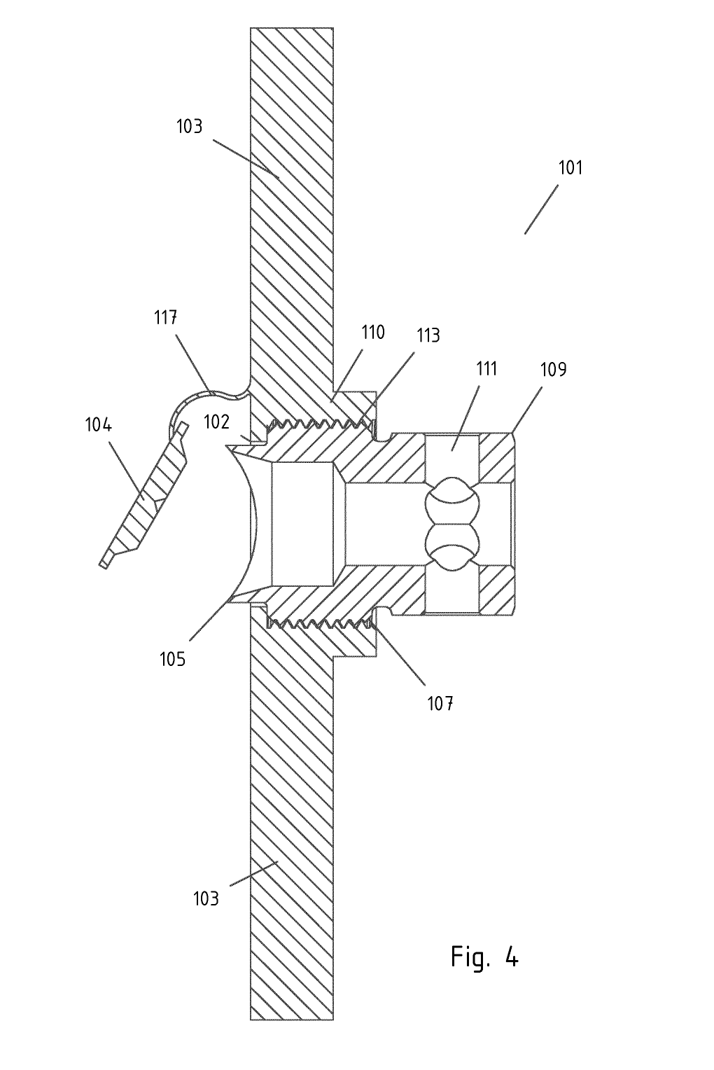

FIG. 4 shows a further schematic representation of a mounting fixture 101 in side view. The cut-out tool 100 is in a state screwed into the threaded connecting piece 110 of the housing wall 103. The cut-out device 105 of the cut-out tool 100 has cut the cutout 104 out of the threaded connecting piece 110, whereby the opening 102 in the housing wall 103 is configured. The securing device 117 ensures the cutout 104 is unable to remain or get lost inside the housing in uncontrolled fashion. Instead, the cutout 104 is secured directly adjacent the opening 102 and can remain there or be manually removed. The securing device 117 would be possible by means of a thin plastic connection, for example. This would completely prevent potential malfunctions of the empty electronics enclosure as well as fragments remaining inside the housing.

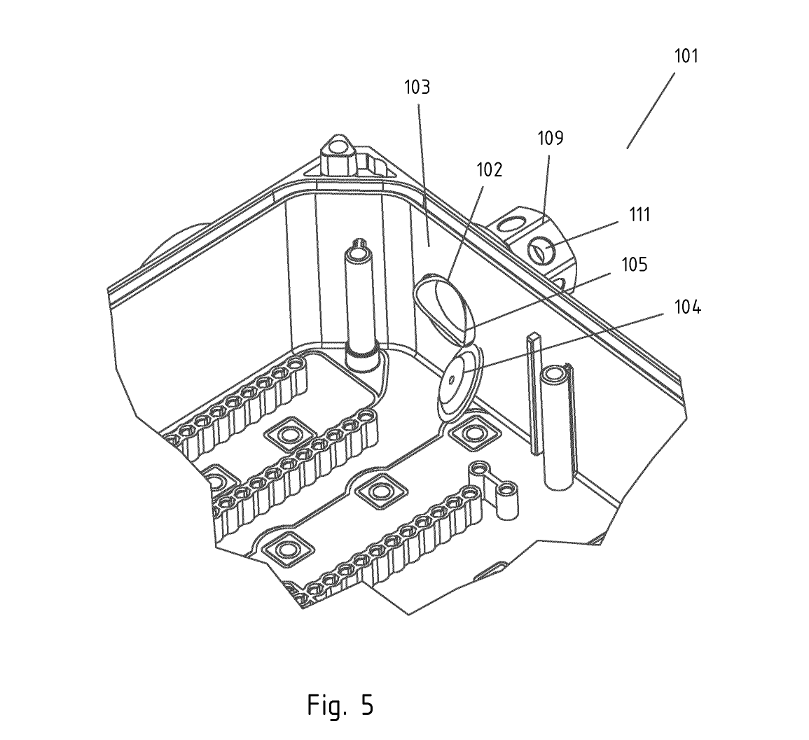

FIG. 5 shows a perspective representation of an mounting fixture 101. The cut-out tool 100 is in the state screwed into the threaded connecting piece 110 of the housing wall 103, wherein the cut-out device 105 of the cut-out tool 100 has cut the cutout 104 out of the threaded connecting piece 110 and whereby the opening 102 is configured in the housing wall 103.

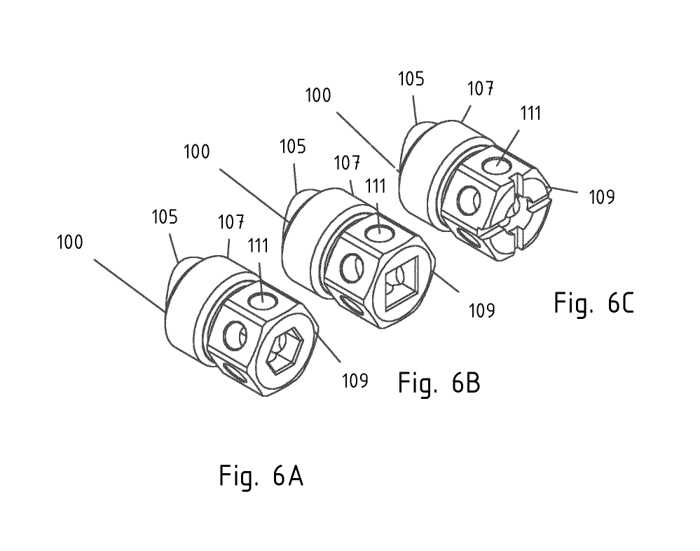

FIG. 6a shows a further perspective representation of a cut-out tool 100. The cut-out tool 100 comprises the cut-out device 105, the thread 107 for screwing the cut-out tool 100 into a threaded connecting piece 110 of a housing wall 103, and the actuating area 109 with the laterally arranged openings 111. An internal hexagon is arranged on the front end of the cut-out tool 100 so as to be able to axially drive the cut-out device 100, for example with an Allen wench.

FIG. 6b shows yet a further perspective representation of a cut-out tool 100. A square socket is arranged on the front end of the cut-out tool 100 so as to be able to axially drive the cut-out device 100 with a square socket key.

FIG. 6c shows yet a further perspective representation of a cut-out tool 100. A cruciform slot is arranged on the front end of the cut-out tool 100 so as to be able to axially drive the cut-out device 100 with a screwdriver or an appropriately held metal strip.

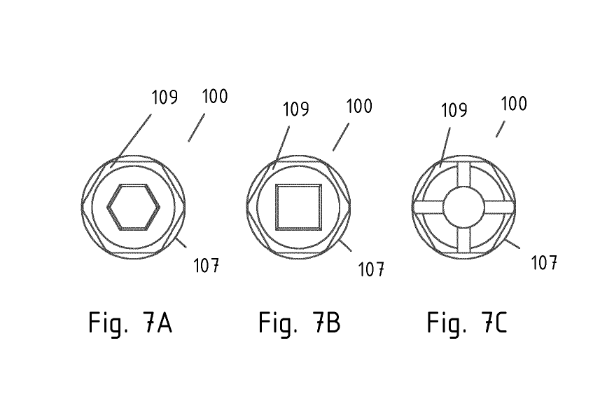

FIG. 7a shows a frontal representation of a cut-out tool 100. The front end of the cut-out tool 100 corresponds to the representation with the internal hexagon from FIG. 6a.

FIG. 7b shows a further frontal representation of a cut-out tool 100. The front end of the cut-out tool 100 corresponds to the representation with the square socket from FIG. 6b.

FIG. 7c shows yet a further frontal representation of a cut-out tool 100. The front end of the cut-out tool 100 corresponds to the representation with the cruciform slot from FIG. 6b.

All of the features described and shown in connection with individual examples of the present disclosure can be provided in different combinations in the inventive subject matter so as to realize their advantageous effects simultaneously.

### LIST OF REFERENCE NUMERALS

100 cut-out tool
101 mounting fixture
102 opening
103 housing wall
104 cutout
105 cut-out device
107 thread
109 actuating area
110 threaded connecting piece
111 lateral openings
113 internal thread
115 protective cap

What is claimed is:

1. A cut-out tool for cutting an opening into a housing wall, comprising:
a cut-out device arranged on an end-face section of the cut-out tool and a thread configured to introduce an opening into the housing wall by screwing the cut-out tool into a threaded connecting piece in or on the housing wall.

2. The cut-out tool according to claim 1, wherein the cut-out tool comprises an actuating area configured to interface with a tool to drive the cut-out tool.

3. The cut-out tool according to claim 2, wherein the actuating area is configured to be radially or axially drivable from the inside or outside, and wherein the tool comprises one w more of: a socket wrench, a ring wrench, a flat wrench, a screwdriver, an Allen wrench, or a cylindrical pin-like tool.

4. The cut-out tool according to claim 2, wherein the actuating area comprises lateral openings configured to radially drive the cut-out tool using the tool, wherein the tool is rod-shaped.

5. The cut-out tool according to claim 1, wherein the end-face cut-out device comprises multiple cutting edges.

6. The cut-out tool according to claim 1, wherein the end-face cut-out device comprises a plurality of merging cylindrical contours.

7. The cut-out tool according to claim 1, wherein the cut-out device comprises a wave-like contour.

8. The cut-out tool according to claim 1, wherein the cut-out device comprises a sawtooth-shaped contour.

9. The cut-out tool according to claim 1, wherein the cut-out device comprises a punch-like cylindrical contour configured to punch out the opening.

10. Tire cut-out tool according to claim 1, wherein at least the cut-out device is made of metal.

11. The cut-out tool according to claim 1, wherein the cut-out tool is formed in one piece.

12. The cut-out tool according to claim 1, wherein the actuating area is a modular component of the cut-out tool.

13. The cut-out tool according to claim 12 wherein the actuating area and the cut-out tool are configured to connect to each other via a plug connection.

14. A mounting fixture, comprising:
a cut-out tool; and
a housing wall comprising with a threaded connecting piece, wherein the threaded connecting piece exhibits an internal thread corresponding to a thread of the cut-out tool; and
wherein cut-out tool comprises a cut-out device arranged on an end-face section of the cut-out tool, the cut-out device comprising the thread of the cut-out tool;
wherein the thread of the cut-out tool is configured to introduce an opening into the housing wall by screwing the cut-out tool into a threaded connecting piece in or on the housing wall.

15. A method for cutting an opening into a housing wall, comprising:
providing a threaded connecting piece on a housing wall;
screwing a cut-out tool into the threaded connecting piece, the cut-oat tool comprising, a cut-out device arranged on an end-face section of the cut-out tool and a thread configured to introduce an opening into the housing wall by screwing of the cut-out tool into the threaded connecting piece; and
cutting the opening into the housing wall using the cut-out device arranged on the end-face section of the cut-out tool.

16. The mounting fixture of claim 14, wherein the cut-out tool comprises an actuating area configured to interface with a tool to drive the cut-out tool.

17. The mounting fixture of claim 16, wherein the actuating area is configured to be radially or axially drivable from the inside or outside, and wherein the tool comprises one or more of: a socket wrench, a ring wrench, a flat wrench, a screwdriver, an Allen wrench, or a cylindrical pin-like tool.

18. The mounting fixture of claim 16, wherein the actuating area comprises lateral openings configured to radially drive the cut-out tool using the tool, wherein the tool is rod-shaped.

19. The mounting fixture of claim 14, wherein the cut-out device comprises multiple cutting edges.

20. The mounting fixture of claim 14, wherein the cut-out device comprises one or more of: a plurality of merging cylindrical contours, a wave-like contour, a sawtooth-shaped contour, or a punch-like cylindrical contour configured to punch out the opening.
